(19) United States
(12) Patent Application Publication
(10) Pub. No.: US 2026/0285547 A1
(43) Pub. Date: Sep. 24, 2026

(54) CLOSURE CAP AND COMBINATION OF A CLOSURE CAP AND REUSABLE CONTAINER

(71) Applicant: ALPLA WERKE ALWIN LEHNER GMBH & CO. KG, Hard (AT)

(72) Inventors: Andreas KAINZ, Waidhofen an der Thaya (AT); Matthias DANGL, Waidhofen an der Thaya (AT); Markus SCHUSTER, Hard (AT); Matthias WIMMER, Waidhofen an der Thaya (AT); Ridheshkumar CHACHAPARA, BREGENZ (AT)

(21) Appl. No.: 19/475,489

(22) PCT Filed: Apr. 26, 2024
(86) PCT No.: PCT/EP2024/061550

§ 371 Date: Oct. 15, 2025

(30) Foreign Application Priority Data
Apr. 28, 2023 (CH) CH000450/2023

(51) Int. Cl. B65D 41/04

(52) U.S. Cl. CPC B65D 41/0421; B65D 2251/20

(57) ABSTRACT

A closure cap for closing the neck of a reusable container, having a circular top plate, a cylindrical threaded part surrounding the top plate and having an open edge and an internal thread, an inner seal protruding from the inside of the top plate and running concentrically, which has a base and a sealing section adjoining the base and extending radially outwards, and an outer seal protruding from the inner transition from the top plate to the threaded part and running concentrically, which extends radially inwards and downwards. The sealing section seamlessly connects to the base and its cross-section tapers continuously to its open end.

### FIELD OF THE INVENTION

The invention relates to a closure cap for closing the neck of a reusable container according to the preamble of claim 1 and to a combination of the closure cap and a reusable container according to claim 12.

### PRIOR ART

A screw closure made of HDPE is known from the prior art, having an inner and an outer sealing lip, which sealing lips protrude from the inside of the top plate of the screw closure. The inner sealing lip comprises a base section and a sealing section, which is connected to the base section by a defined bending point. The closure is intended to reliably seal reusable glass bottles, even when the bottle neck thereof has dimensional inaccuracies or is damaged. This is achieved by the dual seal on the inside and on the outside or end face of the bottle neck. However, the inner and the outer sealing lips have a complicated shape, which can be produced only in an injection mold of complex shape featuring sliders.

### OBJECT OF THE INVENTION

The object, resulting from the disadvantages of the described prior art, is that of providing a screw closure for reusable bottles which is inexpensive to produce and which reliably seals a damaged bottle neck, as is typical in the case of a reusable bottle, without the need for an expensive injection mold or an expensive shaping mold for producing the closure.

### DESCRIPTION

The stated object is achieved in a closure cap by the features listed in the characterizing part of claim 1. Further developments and/or advantageous design variants form the subject matter of the dependent claims.

The invention is preferably characterized in that the sealing section seamlessly connects to the base, and its cross-section tapers continuously toward its open end. This cross-sectional shape, which is reminiscent of a cone or a half-banana, enables the entire inner seal to be forcibly demolded from an injection mold by pulling the inner seal out of its negative mold. The inner seal does not have shapes such as joints or sealing knobs, which can only be demolded if the injection mold has sliders or other complex mold design features. Therefore, the closure cap can be produced in an injection mold that is inexpensive to produce.

It has proven to be useful if the sealing section has a first end, which connects to the base, and has a second, open end. Since the first end connects to the base without a joint, the sealing section can easily be pulled out of its negative mold during the demolding process.

Advantageously, the sealing section extends radially outwards and downwards. As a result, the container neck can reliably bend the sealing section upwards during the screwing-on process, without the sealing section being kinked or bent in the wrong direction.

The invention is also preferably characterized in that the cross-section of the outer seal tapers continuously toward its open end. The outer seal can thus be forcibly demolded in the same way as the first seal, as a result of which the entire closure cap can be forcibly demolded. Due to the conical cross-sectional shape, the outer seal can also be pulled out of its negative mold.

Advantageously, the outer seal has a first end, which connects to the transition between the top plate and the threaded part, and has a second, open end. Since the first end connects to the transition without a joint, there is no shaping of the outer seal, which would make demolding of the outer seal more difficult.

It has proven to be advantageous if the open ends of the sealing section and of the outer seal are rounded. As a result, the open ends can slide along the container neck with low friction when the closure cap is being screwed onto the container neck.

In one particularly preferred embodiment of the invention, a concentric elevation is formed adjacent to the outer seal on the inside of the top plate. This increases the pressure of the outer seal on the outer edge of the end face of the container neck. As a result, the sealing effect between the outer seal and the container neck is easily improved.

It is advantageous if the base has a constant cross-sectional width. This gives the base the shape of a cylindrical shell, which can easily be demolded from the injection mold.

In a further preferred embodiment of the invention, the sealing section is bendable at its first end. This creates a high restoring force and a correspondingly high pressure on the container neck when the neck bends the sealing section outwards.

It is also preferred if the outer seal is bendable at its first end. This creates a high restoring force and a correspondingly high pressure on the container neck when the neck bends the outer seal inwards.

Advantageously, the closure cap is injection-molded from a high-density polyethylene (HDPE). HDPE is the preferred plastic for closure caps and can readily be forcibly demolded from the injection mold.

A further aspect of the invention relates to a combination of the closure cap according to the above description and a reusable container having a neck on which an external thread that cooperates with the internal thread is formed. As already described above, the inner seal and the outer seal are designed in such a way that they can be forcibly demolded from an injection mold, and therefore the injection mold can be produced inexpensively.

In a further preferred embodiment of the invention, when the closure cap is screwed onto the container neck, the sealing section is bent outwards at its first end, and the sealing section bears against the inside of the container neck with a defined surface support by virtue of the restoring force that is generated, which brings about the bending. This creates the largest possible sealing surface between the inside of the container neck and the sealing section.

In a further preferred embodiment of the invention, when the closure cap is screwed onto the container neck, the outer seal is bent inwards at its first end and bears against the outer edge of the end face of the container neck, wherein the elevation intensifies or focuses the pressure on the outer edge. The outer edge of the end face and the elevation lie on a straight line, which forms an angle of approximately 45 degrees with the horizontal. As a result, the pressure of the outer seal on the edge can be increased, and the sealing effect can be improved. The more tightly the closure cap is screwed onto the container neck, the higher the contact pressure of the outer edge and the elevation on the outer seal.

Advantageously, the reusable container is made of plastic, in particular of PET or PEF. It is also preferred if the reusable container is a reusable bottle. Reusable plastic bottles are typically made of PET (polyethylene terephthalate) or PEF (polyethylene furanoate). The unavoidable damage and wear that occurs on the necks of reusable containers can be compensated for by the closure cap according to the invention and the inner and outer seal. Leaks that would occur in combination with conventional closure caps are therefore reliably prevented by the present closure cap.

Further advantages and features will become apparent from the following description of one exemplary embodiment of the invention with reference to the schematic drawings. In the drawings, which are not true to scale:

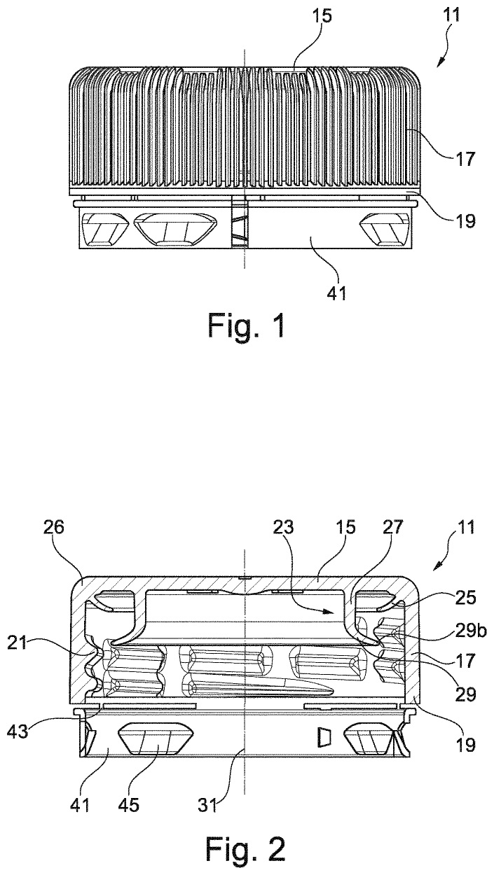

FIG. 1 shows a closure cap in a side view;

FIG. 2 shows a longitudinal section through the closure cap of FIG. 1;

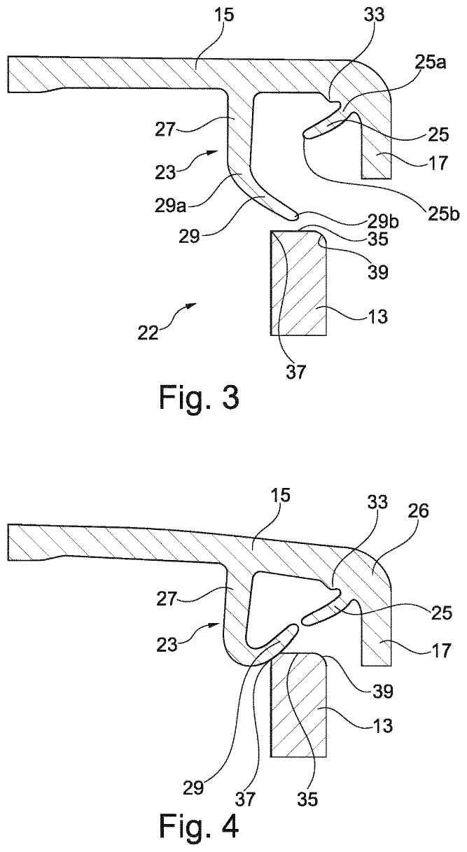

FIG. 3 shows a schematic detail view of the closure cap and a container neck before the cap is screwed onto the neck;

FIG. 4 shows a detail view of the closure cap and the container neck while the cap is being screwed onto the neck; and

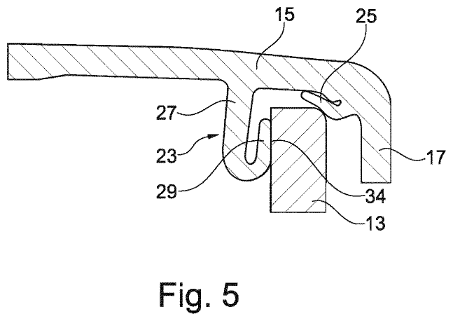

FIG. 5 shows a detail view of the closure cap and the container neck when the cap is screwed onto the neck.

FIGS. 1 to 5 show a closure cap which is denoted as a whole by reference sign 11, which closure cap is preferably injection-molded from HDPE. The closure cap 11 is intended to be screwed onto a container neck 13 of a reusable container. The container has the container neck 13 with an external thread that cooperates with the internal thread 21. The container neck 13 delimits a container opening 22, through which contents are poured into and also out of the container. The container neck 13 is indicated in FIGS. 3 to 5.

The cap 11 has a circular top plate 15 and a cylindrical threaded part 17 surrounding the top plate 15. The threaded part 17 has an open edge 19 and an internal thread 21. The internal thread 21 may be interrupted, as shown in FIG. 2. An inner seal 23 protrudes from the inside of the top plate 15. A concentrically running outer seal 25 protrudes from the inner transition 26 from the top plate 15 to the threaded part 17. The inner seal 23 consists of a base 27, which has a cylindrical shape and is attached to the top plate 15. A sealing section 29 connects to the base 27. The base 27 has a constant cross-sectional width and therefore has the shape of a cylindrical shell.

Both the outer seal 25 and the sealing section 29 have a first end 25a, 29a and a second, open end 25b, 29b. The first end 25a connects to the inner transition 26 between the top plate 15 and the threaded part 17. The first end 29a connects to the base 27.

The outer seal 25 is arranged concentrically around the axis of rotation 31 of the closure cap 11 and extends radially inwards and downwards, i.e., obliquely downwards. The sealing section 29 is likewise arranged concentrically around the axis of rotation 31 and extends radially outwards and downwards, i.e., obliquely downwards. A concentric elevation 33 is formed adjacent to the outer seal 25 on the inside of the top plate 15.

Both the cross-section of the outer seal 25 and that of the sealing section 29 taper toward the open ends 25b, 29b thereof. The open ends 25b and 29b are rounded. The cross-sectional shapes of the outer seal 25 and the sealing section 29 are reminiscent of the shape of a half-banana. This specific shape means that the closure cap 11 can be forcibly demolded from an injection mold. The injection mold can therefore be of simple and uncomplicated design and is thus inexpensive to produce. Therefore, compared to an injection mold in which an above-described closure cap of the prior art is produced, there is no need for sliders or other complicated mold design features. Although the closure cap 11 according to the invention can be produced in an inexpensive injection mold, it reliably seals the bottle neck 13 of a reusable container, even when this is filled with carbonated beverages, which lead to overpressure.

FIGS. 3 to 5 show how the inner and the outer seals 23, 25 sealingly cooperate with the neck 13: In FIG. 3, the neck 13 is still spaced apart from the two seals 23, 25.

When the cap 11 is screwed further onto the neck 13, the end face 35 of the neck comes into contact with the sealing section 29 first with its inner edge 37. Since the sealing section 29 is bendable at its first end 29a, the sealing section 29 is bent outwards from the neck (FIG. 4).

When the closure cap 11 is fully screwed onto the neck 13, the flexible sealing section 29 is bent outwards, as a result of which a restoring force is generated. The sealing section 29 thus bears sealingly against the inside of the container neck with a defined surface support 34. Almost the entire surface of the side of the sealing section 29 facing towards the neck 13 serves as a sealing surface.

The end face 35 bends the outer seal 25 upwards until it hits the elevation 33. The elevation 33 is arranged on the inside of the top plate 15 in such a way that it substantially lies on a 45° line that runs through the outer edge 39. As a result, the pressure of the outer seal 25 on the outer edge is intensified by the elevation. This leads to a further improvement in the sealing of the neck 13.

The design of the two seals 23, 25 leads to the closure cap reliably sealing even the neck 13 of a reusable container that is damaged or worn due to repeated use. The two seals are also able to compensate for dimensional inaccuracies of the neck 13. It is preferred if the reusable container is a reusable bottle made of PET or PEF. Use with reusable glass bottles is also conceivable, the necks of which are prone to dimensional inaccuracies and damage due to chipping.

The closure cap 11 can also have the function of a tamper-proof closure. To this end, a tamper-proof ring 41 with predetermined breaking webs 43 can be held on the open edge 19. When the closure cap 11 is unscrewed for the first time, the tamper-proof ring 41 is held on the neck 13 by holding elements 45. The predetermined breaking webs 43 break when the threaded part 17 moves axially away from the tamper-proof ring 41.

### LIST OF REFERENCE SIGNS

11 closure cap
13 container neck
15 top plate
17 threaded part
19 open edge
21 internal thread
23 inner seal
25 outer seal
25a, 25b first and second end of the outer seal
26 transition from the top plate to the threaded part
27 base
29 sealing section
29a, 29b first and second end of the sealing section
31 axis of rotation
33 elevation
34 surface support
35 end face of the neck
37 inner edge of the end face
39 outer edge of the end face
41 tamper-proof ring
43 predetermined breaking webs
45 holding elements

1.-15. (canceled)

16. A closure cap for closing the neck of a reusable container, comprising:
a circular top plate,
a cylindrical threaded part surrounding the circular top plate and having an open edge and an internal thread,
an inner seal protruding from inside of the circular top plate and extending concentrically, which includes a base and a sealing section adjoining the base and extending radially outwards, and
an outer seal protruding from an inner transition from the circular top plate to the cylindrical threaded part and extending concentrically, which extends radially inwardly and downwardly,
wherein
the sealing section seamlessly connects to the base, the sealing section having a cross-section which tapers continuously toward an open end.

17. The closure cap according to claim 16, wherein the sealing section comprises a first end, which connects to the base, and a second, open end.

18. The closure cap according to claim 16, wherein the sealing section extends radially outwardly and downwardly.

19. The closure cap according to claim 16, wherein the outer seal further comprises cross-section which tapers continuously toward an open end.

20. The closure cap according to claim 16, wherein the outer seal further comprises a first end, which operatively couples to a transition between the circular top plate and the cylindrical threaded part, and a second, open end.

21. The closure cap according to claim 20, wherein the open end of the sealing section and the open end of the outer seal are rounded.

22. The closure cap according to claim 16, further comprising a concentric elevation formed adjacent to the outer seal on an inner side of the top plate.

23. The closure cap according to claim 16, wherein the base comprises a constant cross-sectional width.

24. The closure cap according to claim 17, wherein the sealing section is bendable at its first end.

25. The closure cap according to claim 20, wherein the outer seal is bendable at its first end.

26. The closure cap according to claim 16, wherein the closure cap comprises an injection-molded high-density polyethylene.

27. In combination:
a closure cap for closing the neck of a reusable container, comprising:
a circular top plate,
a cylindrical threaded part surrounding the circular top plate and having an open edge and an internal thread,
an inner seal protruding from inside of the circular top plate and extending concentrically, which includes a base and a sealing section adjoining the base and extending radially outwards, and
an outer seal protruding from an inner transition from the circular top plate to the cylindrical threaded part and extending concentrically, which extends radially inwardly and downwardly,
wherein the sealing section seamlessly connects to the base, the sealing section having a cross-section which tapers continuously toward an open end; and
a reusable container comprising a neck and an interior surface and an exterior surface having formed thereon an external thread,
wherein the external thread of the reusable container operatively couples with the internal thread of the cylindrical threaded part.

28. The combination according to claim 27, wherein when the closure cap is operatively coupled to the neck of the reusable container, the sealing section is bent outwardly at its first end and bears against the interior surface of the container neck with a defined surface support by virtue of the restoring force generated by the outward bending.

29. The combination according to claim 27, wherein when the closure cap is operatively coupled to the neck of the reusable container, the outer seal is bent inwardly at a first end and bears against an outer edge of an end face of the neck of the reusable container, wherein an elevation intensifies or focuses pressure on the outer edge of an end face of the neck of the reusable container.

30. The combination according to claim 27, wherein the reusable container comprises plastic, and wherein the plastic comprises at least one PET or PEF.
